(19) United States
(12) Patent Application Publication
(10) Pub. No.: US 2026/0008155 A1
(43) Pub. Date: Jan. 8, 2026

(54) COLLECTION TOOL FOR SWARF REMOVAL FROM A SKATE SHARPENER

(71) Applicant: Velasa Sports, Inc., Acton, MA (US)

(72) Inventors: Daniel A. Beaudet, Lexington, MA (US); Russell K. Layton, Jr., Acton, MA (US); Ivan Perez-Petkov, Boston, MA (US); David Michael Lewis, Jr., Burlington, MA (US); Joseph Patrick Tracy, Hutchinson, MN (US); Scott Logcher, Woburn, MA (US)

(21) Appl. No.: 19/130,877

(22) PCT Filed: Jan. 17, 2024
(86) PCT No.: PCT/US2024/011810

§ 371 Date: May 16, 2025

Related U.S. Application Data
(60) Provisional application No. 63/480,491, filed on Jan. 18, 2023.
(60) Provisional application No. 63/587,415, filed on Oct. 2, 2023.

(51) Int. Cl. B24B 55/06; B03C 1/02

(52) U.S. Cl. CPC B24B 55/06; B03C 1/02

(57) ABSTRACT

A collection tool for collecting metallic debris can comprise a handle, a sheath, and a plunger. The handle can comprise a handle body and a first channel extending through the handle body between a distal opening a proximal opening. The sheath can extend from the distal end of the handle body and can comprises a sheath body and a second channel extending through the sheath body between a distal end and a proximal opening aligned with the distal opening of the first channel. The plunger can comprise a plunger body compressing one or more magnets and configured to move the magnets along the channels, and a plunger handle at a proximal end of the plunger body. The plunger handle is configured to move the plunger between a first configuration with the magnets near the distal end of the second channel and a second configuration with the magnets positioned within the first channel.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the benefit of U.S. Provisional Patent Application No. 63/587,415, filed Oct. 2, 2023, and U.S. Provisional Patent Application No. 63/480,491, filed Jan. 18, 2023, the entire contents of which are hereby incorporated by reference in its entirety.

### BACKGROUND

### Field

The present disclosure relates to the field of metallic debris removal in skate sharpening systems.

### Description of the Related Art

During machining operations, such as sharpening and profiling operations performed on a skate sharpener system, metal can be removed from a skate blade using a grinding wheel. The removed metal is in the form of metallic dust (“swarf”). As continuous operations are performed, the swarf builds up inside of and around the machine as well as within the workspace where the operations are performed. The swarf builds up within the sharpener and can accelerate the failure of bearing systems, interfere with sensors, reduce system visibility, and/or cause other issues within the sharpener. The swarf can also impede or cause damage to electrical components of the sharpener.

For optimal sharpener performance, swarf removal is a necessary operation that must be performed regularly. Conventional methods of swarf removal include using air cleaning processes or devices (e.g., vacuums and blowers) as well as brushes. These methods may remove some swarf from the sharpener but can lead to the spreading of swarf around the workspace. Additionally, these methods can be ineffective at removing swarf from hard to access locations within the sharpener and in some cases may cause damage to components of the sharpener. There is a need for improved technologies to facilitate swarf removal from skate sharpeners in an efficient and consistent manner without causing damage to the skate sharpener.

### SUMMARY

The present disclosure relates to devices and methods which improve the current state of the art for removing swarf from skate sharpening systems.

Various systems, methods, and devices are disclosed for the removal of swarf from skate sharpening systems. The systems, methods, and devices of the disclosure each have several innovative aspects, no single one of which is solely responsible for the desirable attributes disclosed herein.

In some embodiments, a collection tool for collecting metallic debris is disclosed. The collection tool can include a handle, a sheath, and a plunger. The handle can comprise a handle body having a proximal end and a distal end; and a first channel extending through the handle body between a distal opening at the distal end and a proximal opening at the proximal end. The sheath can extend from a distal end of the handle body. The sheath can comprise a sheath body; and a second channel extending through the sheath body between a distal end and a proximal opening at the proximal end, the proximal opening of the second channel aligned with the distal opening of the first channel. The plunger can comprise a plunger body comprising one or more magnets, the plunger body configured to move the one or more magnets along the first channel and the second channel; and a plunger handle positioned at a proximal end of the plunger body. The plunger handle is configured to move the plunger between a first configuration and a second configuration, wherein the one or more magnets are positioned near the distal end of the second channel in the first configuration and the one or more magnets are positioned within the first channel in the second configuration.

The methods and devices disclosed herein may result in one or more of the following advantages over current swarf removal methods. One advantage may be improving the ability to collect swarf from small crevices and other hard to reach areas of the skate sharper. Another advantage may be improving the ability to collect swarf without damaging mechanical and electrical components of the sharpener. Yet another advantage may be improving the ability to collect and dispose of swarf without spreading the swarf over a user's workspace.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings. The accompanying drawings, which are incorporated in, and constitute a part of, this specification, illustrate embodiments of the disclosure. Embodiment of the present disclosure are illustrated by way of example, and not by way of limitation, in the figures of the accompanying drawings and in which like references indicate similar elements. According to common practice, the various features of the drawings discussed below are not necessarily drawn to scale. The drawings are provided to illustrate example embodiments described herein and are not intended to limit the scope of the disclosure.

FIG. 1A illustrates a perspective view of an embodiment of a collection tool.

FIG. 1B illustrates a perspective view of the collection tool of FIG. 1A with certain components removed.

FIG. 2A illustrates a cross-sectional side view of the collection tool of FIG. 1A.

FIG. 2B illustrates a cross-sectional top view of the collection tool of FIG. 1A.

FIG. 3 illustrates the collection tool of FIG. 1A being used to remove swarf from a skate sharpener system.

FIG. 4A illustrates a perspective view of the collection tool of FIG. 1A in an extended configuration with certain components shown in cross-section for illustrative purposes.

FIG. 4B illustrates a perspective view of the collection tool of FIG. 1A in a partial retracted configuration with certain components shown in cross-section for illustrative purposes.

FIG. 4C illustrates a perspective view of the collection tool of FIG. 1A in a retracted configuration with certain components shown in cross-section for illustrative purposes.

FIG. 5A illustrates a perspective view of the collection tool of FIG. 1A in the extended configuration with collected swarf.

FIG. 5B illustrates a perspective view of the collection tool of FIG. 1A in the retracted configuration to remove the collected swarf.

FIG. 6 illustrates a perspective view of the collection tool of FIG. 1A with an integrated swarf collection system.

FIG. 7 illustrates a perspective view of another embodiment of a collection tool with a curved sheath.

### DETAILED DESCRIPTION OF SOME EMBODIMENTS

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” or “another embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

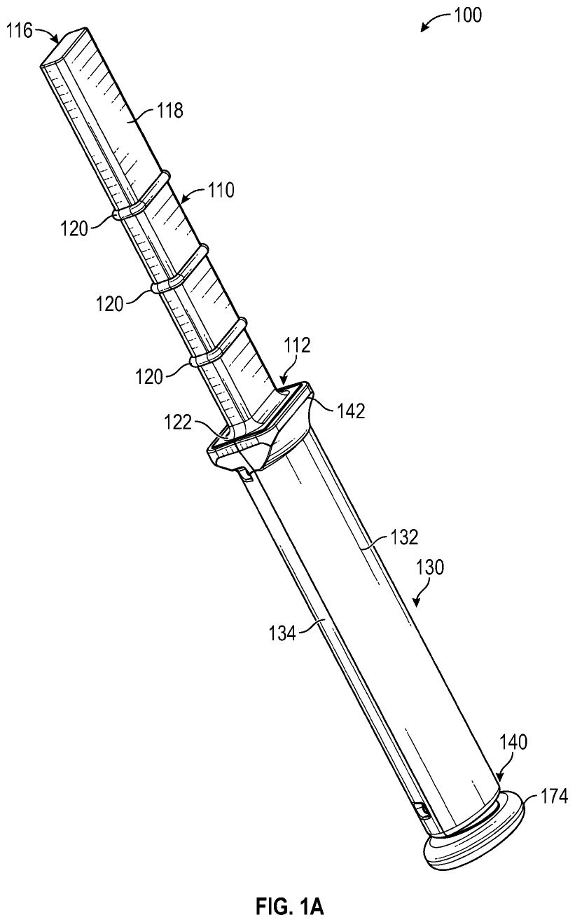

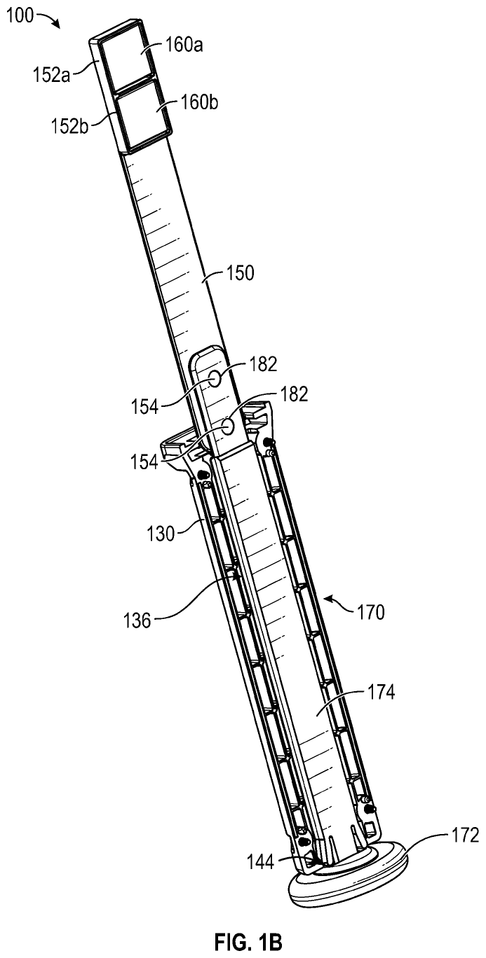

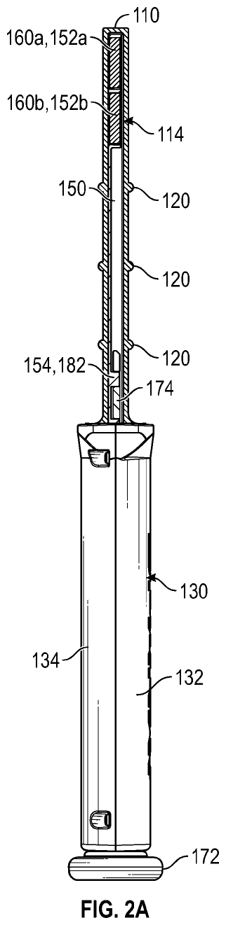

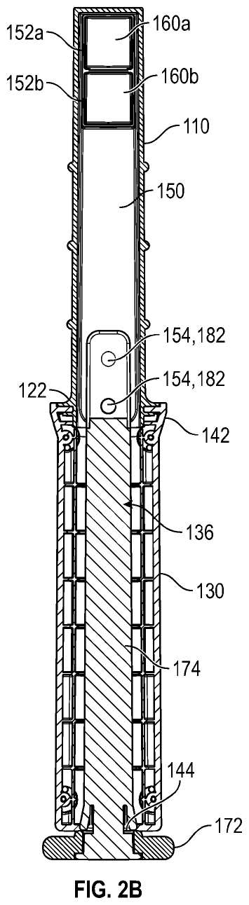

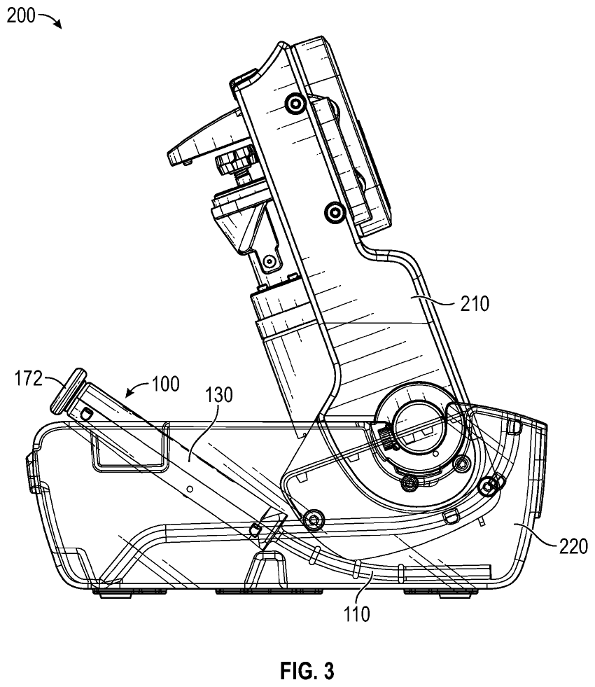

FIGS. 1A-2B illustrate various views of an embodiment of a swarf collection and removal tool 100 (referred to herein as “collection tool 100”). The collection tool 100 can be used to collect ferromagnetic metallic dust and debris (“swarf”) in and around a skate sharpener system (see e.g., skate sharpener 200 of FIG. 3). Swarf may be generated when the sharpener 200 is used to grind a skate blade, such as during a sharpening, profiling, or other similar grinding operations performed on the sharpener 200. Although skate blades generally consist of stainless steel, the swarf from ice skate blades is ferrous and magnetizable. While this disclosure provides specific example use cases for using the collection tool 100 with the sharpener 200, it is recognized that the collection tool 100 can be used to collect swarf or other ferromagnetic material in other applications, such as in other mechanical or machining systems where ferromagnetic materials is generated and removal of the material is desired.

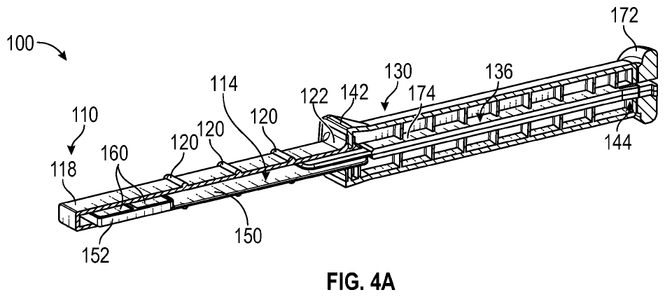

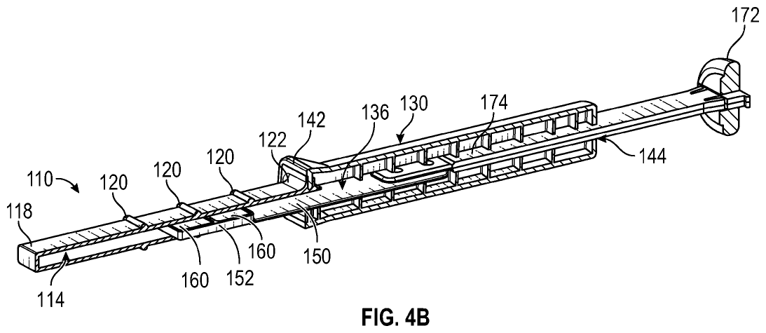

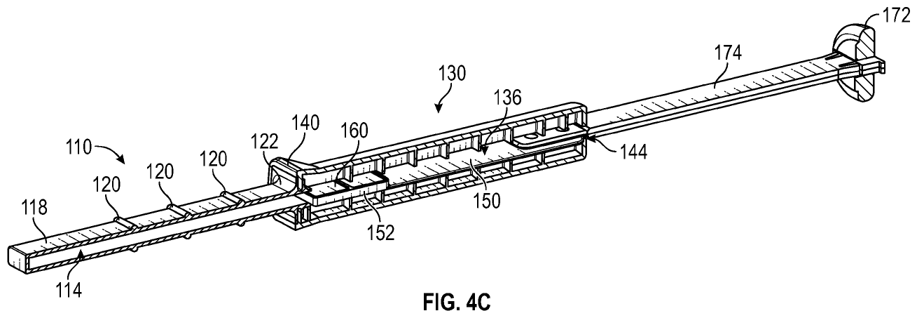

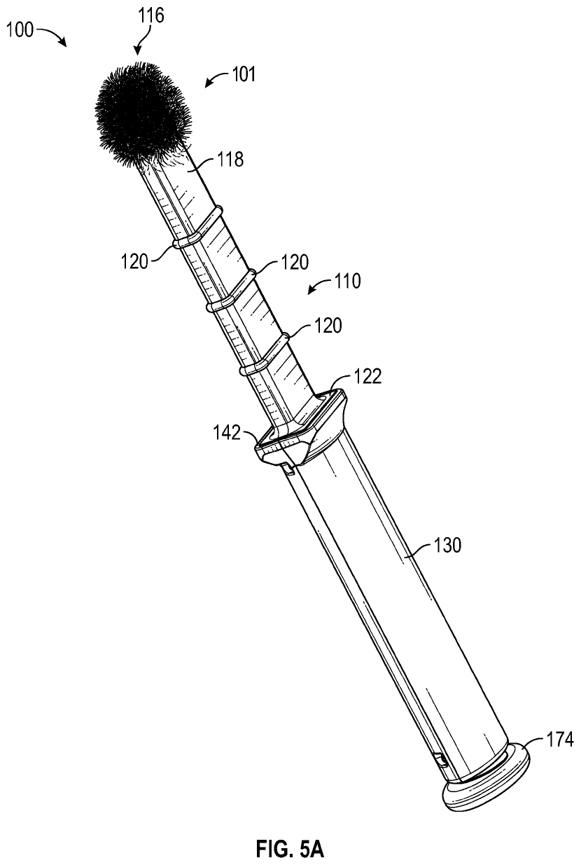

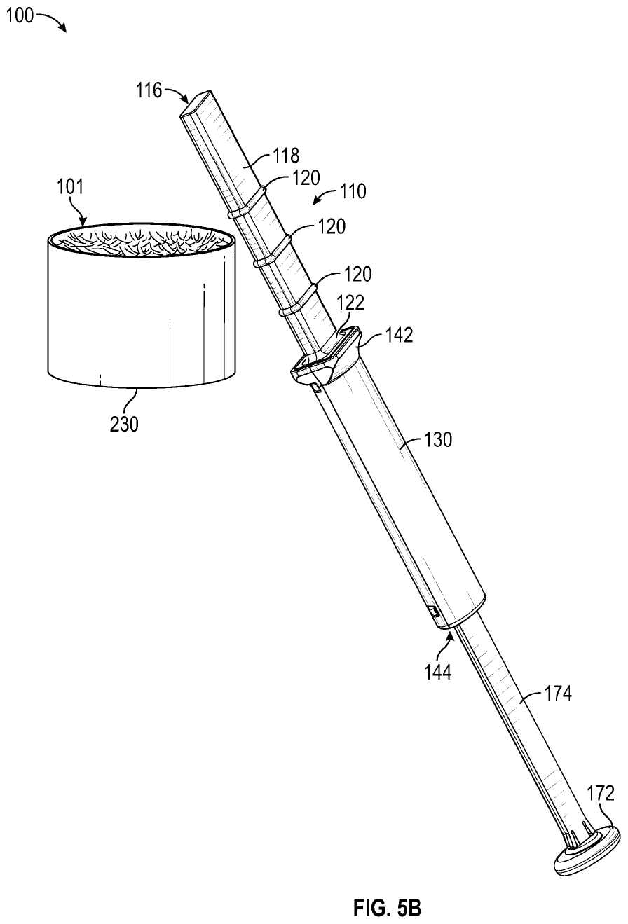

FIG. 1A illustrates a perspective view of the collection tool 100 and FIG. 1B illustrates a perspective view of the collection tool 100 with certain components removed. The collection tool 100 includes a sheath 110, a handle 130, a magnet holder 150, one or more magnets 160, and a plunger 170. A user can hold the collection tool 100 via the handle 130 and collect swarf on the outside of the sheath 110 when the magnet holder 150 and magnets 160 are in an extended position (see e.g., FIGS. 4A and 5A). The user can deposit the swarf in another location, such as a collection bin, by moving the plunger 170 into a retracted position, which causes the magnet holder 150 and the magnets 160 to move from within the sheath 110 to within the handle 130 (see e.g., FIGS. 4C and 5B). Use and operation of the collection tool 100 is described further with reference to at least FIGS. 4A-5B.

As shown in FIG. 1A, the sheath 110 is coupled to the handle 130 at its proximal end 112. The sheath 110 is configured to collect swarf on its external surface 118 when in use. The sheath 110 serves as a protective barrier that provides separation between the magnets 160 and the collected swarf. As shown in FIGS. 2A and 2B, which illustrate side and top section-views of the collection tool 100 respectively, the sheath 110 includes a sheath channel 114. The sheath channel 114 can be slot, groove, and/or pathway extending through the body of the sheath 110. The sheath channel 114 extends between the proximal end 112 and a distal end 116 of the sheath 110. The sheath channel 114 is aligned with a handle channel 136 that extends through the body of the handle 130, such that a continuous channel extends through the collection tool 100. The sheath channel 114 and the handle channel 136 are aligned along a longitudinal axis. The continuous channel allows the magnet holder 150 to travel between the extended position, where the magnet holder 150 and the magnets 160 are positioned within the sheath channel 114 and the retracted position, where the magnet holder 150 and the magnets 160 are positioned with the handle channel 136.

The sheath 110 can include one or more ridges 120 formed on the external surface 118. In the illustrated example, the sheath 110 includes three ridges 120 spaced apart between the proximal end 112 and the distal end 116; however, it is recognized that other embodiments of the collection tool 100 may include more or less ridges 120. The ridges 120 can be raised portions that extend laterally around the external surface 118 of the sheath 110. As the magnets 160 move from the extended configuration to the retracted configuration, the ridges 120 can provide stopping points for the collected swarf along the sheath 110. For example, because the swarf is magnetically attracted to the magnets 160, movement of the magnets 160 along the sheath channel 114 causes the swarf to travel proximally along the external surface 118 of the sheath 110 with the magnets 160. The ridges 120 can provide stopping points along the external surface 118 for the swarf to separate from the moving magnets 160 such that the swarf drops off the external surface 118 and does not follow the magnets 160. The ridges 120 have two mechanisms to cause the swarf to separate from the collection tool 100. The first mechanism is that the ridges 120 are a physical barrier to the swarf sliding smoothly on the sheath 110. The second mechanism is that the ridges 120 increase the separation distance of the swarf to the magnets 160, thereby reducing the magnetic attraction force holding the swarf to the sheath 110. Further, by including multiple ridges 120 along the length of the sheath 110, each successive ridge 120 can stop additional swarf from the traveling in the proximal direction, reducing the amount of swarf that collects on the proximal end 112 of the sheath 110.

To prevent any collected swarf from traveling with the magnets 160 into the handle 130, the sheath 110 can include a sheath guard 122 located near the proximal end 112. As shown in FIGS. 2A and 2B, a portion of the sheath 110 can extend into the handle channel 136 to connect the sheath 110 to the handle 130, and the sheath guard 122 can abut a distal end 142 of the handle 130. The sheath guard 122 can be a flared portion of the sheath 110 and has a greater height and width than the majority of the sheath 110. The sheath guard 122 provides a barrier for the collected swarf, so that no swarf enters the handle channel 136. Once the magnets 160 have moved into the full retracted position within the handle channel 136, any swarf collected on the sheath guard 122 has minimal magnetic attraction to the magnets 160 and is released or dislodged from the collection tool 100. In some cases, a user may need to shake the collection tool 100 or knock the collection tool 100 against the collection bin to remove any remaining swarf on the sheath guard 122.

In some cases, the sheath 110 can be flexible. For example, the sheath 110 can be made of silicone, plastic, rubber, elastomer, Thermoplastic Polyurethane (“TPU”), and/or any other suitable material that can bend without permanent deformation and return to a relaxed rigid state. A flexible sheath 110 can allow the sheath 110 to conform to the shape of an area where swarf is to be collected. For example, as shown in FIG. 3, the sheath 110 can conform to the shape of the base 220 of the sharpener 200. A collection tool 100 with a flexible sheath 110 can have particular benefits when used to clean hard to reach locations. The sheath 110 can conform to access narrow or curved locations within the sharpener 200, such as between the body 210 and the base 220 of the sharpener 200. As swarf can collect in hard to access areas of the sharpener 200, the flexible sheath 110 can penetrate the hard to access areas to safely remove the collected swarf. Additionally, a flexible sheath 110 can prevent damage to any sensitive components of the sharpener 200, such as the electronic components. The sheath 110 may be sized and configured based on the type of device or component that it is cleaning. The length, width, thickness, shape, and flexibility of the sheath may be determined based on the use case for the collection tool 100. For example, the sheath may be a different shape, such as circular, square, rectangular, triangular, or another shape. The sheath may have a uniform shape (such as illustrated), or may be nonuniform, such as a tapered shape with a narrower tip and a wider base, or a triangular or needle-like tip and a rectangular shaft. In such an instance, the magnets 160 may not have a uniform shape (e.g., a first magnet may have a different shape than a second magnet) and can be shaped based on the shape of the sheath. The length and flexibility of the sheath may be configured to bend around corners of a specific curvature of a device (e.g., the skate sharpener 200).

In other implementations, the sheath 110 can be non-flexible or rigid such that the sheath 110 deforms minimally when contacting hard surfaces. A non-flexible sheath 110 can provide certain benefits, such as increasing the amount of swarf that can be collected on the sheath 110. A non-flexible sheath 110 can be used to clean workspaces and other machinery where there are no hard to access locations. A non-flexible sheath 110 can also be used for other applications of the collection tool 100, such as collecting ferromagnetic components such as fasteners in a workspace.

In some implementations, the sheath 110 can be disposable or can include a replaceable cover that is configured to extend over the sheath 110. The replaceable cover can be made of a fibrous or cloth material that can be used to collect additional debris that is not ferromagnetic, in addition to the swarf. After one or more collection operations, the replaceable cover can be disposed, and a new cover can be used with the collection tool 100 for the next cleaning operation. In some implementations, the sheath 110 can include a brush (e.g., a bristle brush) which may be located on the distal end 116. The brush can be used to help loosen any swarf that adheres to the sharpener 200 due to, for example, the presence of grease or other congealing liquid. In some implementations, the collection tool 100 may include a small vacuum to induce any airborne particles to be drawn into the collection tool 100.

Referring back to FIGS. 1A and 1B, the collection tool 100 includes the handle 130. The handle 130 can allow a user to hold the collection tool 100 and manipulate the sheath 110. The handle 130 can include a top cover 132 and a bottom cover 134. The top cover 132 and the bottom cover 134 can be coupled together by any conventional means, such as fasteners that extend between the top cover 132 and the bottom cover 134. Connecting the covers 132, 134 can allow the sheath 110 to be coupled to the handle 130, with the proximal end 112 of the sheath 110 secured between the top cover 132 and the bottom cover 134. The handle 130 includes the handle channel 136 defined by the top cover 132 and the bottom cover 134. The handle channel 136 extends between a proximal end 140 and the distal end 142 of the handle 130. The proximal end 140 of the handle 130 includes an opening 144 that is aligned with the handle channel 136 and is configured to allow the plunger 170 to move in and out of the handle channel 136. The handle channel 136 is aligned with the sheath channel 114 and can house the magnet holder 150, the plunger 170, or a portion of both, depending on if the collection tool 100 is in the retracted configuration, the extended configuration, or somewhere in between. The distal end 142 of the handle 130 can be a flared region having a greater height and/or width that the remainder of the handle 130. The flared distal end 142 can, in combination with the sheath guard 122, serve as a stopping point for any swarf that collects at the proximal end 112 of the sheath 110. Additionally, because the handle 130 and the flared distal end 142 increase the distance between the magnets 160 and the swarf, the magnetic attraction may be sufficiently reduced such that the swarf is released from the collection tool 100.

As shown in FIG. 1B, the collection tool 100 includes the magnet holder 150. The magnet holder 150 is configured to house the magnets 160 and allow the magnets 160 to move along the sheath channel 114 and the handle channel 136. The magnet holder 150 is coupled to the plunger 170, such that the user can cause translation of the magnet holder 150 by movement of the plunger 170. Translation of the magnet holder 150 can be linear along the longitudinal axis of the collection tool 100. For example, the magnet holder 150 can include one or more projections 154 located near its proximal end. The projections 154 can be received within projection openings 182 located near the distal end of the plunger 170, such that the magnet holder 150 is coupled to the plunger 170 and moves with the plunger 170.

The magnet holder 150 can include one or more magnet compartments 152 for receiving the magnets 160. In the illustrated example, the collection tool 100 include two magnets 160, a first magnet 160a and a second magnet 160b. As such, the magnet holder 150 include a first compartment 152a and a second compartment 152b to receive the magnets 160a, 160b respectively. In some cases, the magnets 160 may be coupled to the magnet compartments 152 using an adhesive. In some cases, the walls of the compartments 152a, 152b secure the magnets 160a, 160b within the collection tool 100 without the use of adhesive. In other cases, the magnets 160 may be coupled to the magnet compartments 152 using a tape, wrap, and/or heat shrink that wraps around the magnets and secures the magnets to the magnet holder 150. For example, the magnet holder 150 may have features or protrusions on the surface of the magnet holder 150 that that the heat shrink, tape, or wrap can mechanically lock to when the magnets 160 are wrapped.

Like the sheath 110, the magnet holder 150 can be flexible. For example, the magnet holder 150 can be made of silicone, plastic, rubber, elastomer, TPU, and/or any other suitable material that can bend without permanent deformation. A flexible magnet holder 150 allows the magnet holder 150 to bend and conform to the shape of the sheath 110, when the sheath 110 conforms to the shape of an area where swarf is to be collected. In an implementation where the sheath 110 is not flexible, the magnet holder 150 can be made of a flexible or non-flexible material. As shown in FIG. 2A, the magnet holder 150, along with the magnets 160, can be sized to have a clearance fit with the sheath channel 114 and the handle channel 136. A clearance fit provides a gap between the magnet holder 150 and the channels 114, 136 such that the magnet holder 150 can translate easily within the channels 114, 136. The clearance fit may also prevent the magnets 160 from being separated from the magnet holder 150 as there is not sufficient room for the magnets 160a, 160b to be removed from the compartment 152a, 152b.

The plunger 170 can be used to move the magnets 160 within the channels 114, 136. The plunger 170 can include a plunger handle 172 and a plunger rod 174. The plunger rod 174 can be coupled to the plunger handle 172 at its proximal end such that the plunger rod 174 extends distally from the plunger handle 172. The plunger rod 174 is coupled to the magnet holder 150. For example, as described herein, the plunger rod 174 can include one or more projection openings 182 located near the distal end that are configured to receive the projections 154 of the magnet holder 150. As such, translation of the plunger 170 causes corresponding translation of the magnet holder 150. The plunger handle 172 is positioned outside of the handle 130, allowing the user to grasp the handle 130 in one hand and the plunger handle 172 in the other hand. The plunger handle 172 can be larger than the handle channel 136, preventing the plunger handle 172 from entering the handle channel 136. In the extended configuration, the plunger rod 174 extends through and is positioned within the sheath channel 114 and the handle channel 136 (see e.g., FIG. 4A). As the user pulls on the plunger rod 174, the plunger handle 172 travels along the channels 114, 136 and outside of the handle 130 (see e.g., FIGS. 4B and 4C). The plunger rod 174 can be sized to have a clearance fit with the sheath channel 114 and the handle channel 136. A clearance fit provides a gap between the plunger rod 174 and the channels 114, 136 so that the plunger rod 174 can translate easily within the channels 114, 136.

As shown in FIG. 2B, the plunger rod 174 can have a smaller width than the magnet holder 150. The handle channel 136 can be sized to accommodate the widths of both the plunger rod 174 and the magnet holder 150, allowing both components to travel within the handle channel 136. The opening 144 in the handle 130 can be sized to have a similar width to the plunger rod 174 and a smaller width that the magnet holder 150, so that the plunger rod 174 can travel through the opening 144 but the magnet holder 150 cannot. As such, the magnet holder 150 does not extend through the opening 144 when the collection tool 100 is in the retracted configuration. Interaction between the magnet holder 150 and the proximal end 140 of the handle 130 serves as a stopping point for the retraction of the plunger 170.

FIGS. 4A-4C illustrate partial section views of the collection tool 100 in the extended configuration, a partial retracted configuration, and the fully retracted configuration respectively. As shown in FIG. 4A, in the extended configuration, the magnet holder 150 is located within the sheath channel 114 with the magnets 160 positioned near the distal end 116 of the sheath 110. In the extended configuration, the collection tool 100 can be used to collect swarf, and the swarf will accumulate near the distal end 116. For example, FIG. 5A shows the collection tool 100 with collected swarf 101 schematically illustrated. As the user begins to pull on the plunger 170, the magnets 160 are moved proximally away from the distal end 116 and into a partial retracted configuration shown in FIG. 4B. Movement of the magnets 160 causes the collected swarf to also move away from the distal end 116 due to the magnetic attraction between the swarf and the magnets 160. As the user continues to pull on the plunger 170, generally, at least a portion of the swarf will travel along the external surface 118 of the sheath 110 and contact the ridges 120, causing some of the swarf to be dislodged from the collection tool 100. As the user continues to pull on the plunger 170, the magnets 160 move to the fully retracted configuration, shown in FIG. 4C, where the magnets 160 are positioned within the handle channel 136. The sheath guard 122 prevents any of the swarf from entering the handle 130 and may cause a portion of the swarf to form on the distal end 142 of the handle and a majority of the swarf to be released from the collection tool 100. Generally, the user positions the collection tool 100 over a container, such as the collection bin 230 shown in FIG. 5B, before moving the collection tool 100 from the extended configuration to the retracted configuration. In this arrangement, the collected swarf can be smoothly transferred to the collection bin 230 for disposal or other use.

In some implementation, the collection tool 100 may include an electromagnet instead of the permanent magnets 160. For example, the magnet holder 150 may include a core material (e.g., iron) surrounded by a coil or wire (e.g., copper) along at least a portion of the length of the magnet holder 150. The collection tool 100 may further include a power source, such as a battery that can be housed in the handle 130 and is configured to provide electrical current through the coil. The handle 130 can include a switch that is connected to the battery that can selectively open and close the circuit. When the switch is closed and the circuit is complete, the current flowing through the wire creates a magnetic field, allowing the collection tool 100 to be used to collect swarf on the sheath 110. The user could open the switch to break the circuit so that the magnetic field dissipates, allowing the swarf to become dislodged from the collection tool 100. In some implementations, the electromagnetic collection tool 100 may include a reversing electromagnetic. For example, the electromagnet may be able to change the direction of the magnetic field using the switch or other control system. A reversing electromagnet collection tool 100 could be used to repulse the swarf away from the collection tool 100.

In some implementations, the collection tool 100 can be used for other applications, such as collecting other ferromagnetic material or components, such as fasteners (e.g., bolts, nuts, screws, washers, etc.). A user could use the collection tool 100 to collect one or more of these components and selectively pull the plunger 170 to relocate the components. This use may provide a benefit of allowing the user to collect and transport ferromagnetic components, particularly when the components are in hard to access areas.

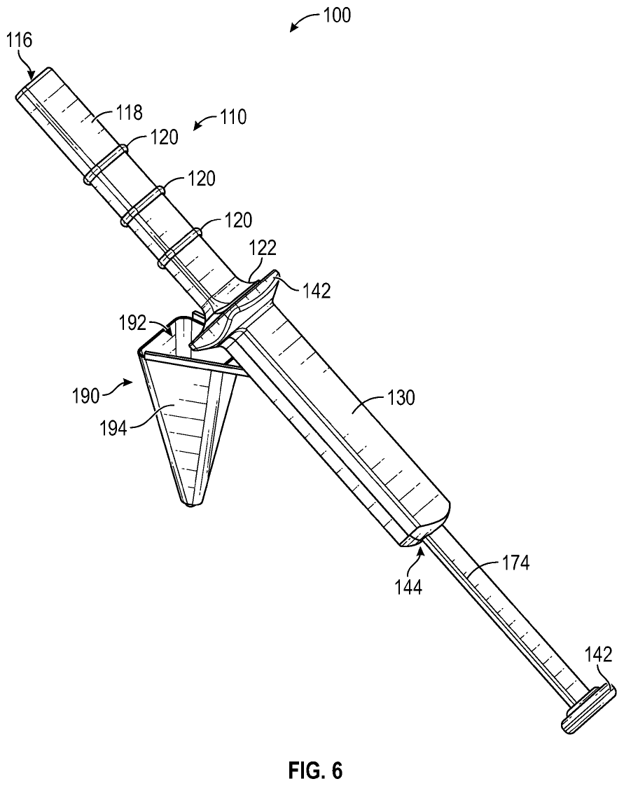

FIG. 6 illustrates a perspective view of an embodiment of the collection tool 100 that includes an integrated collection bin 190. The integrated collection bin 190 can be coupled to the handle 130. In some cases, the integrated collection bin 190 may have a hinged connection to the handle 130. The integrated collection bin 190 can include a top opening 192 and a closed bottom portion, which may be formed by side walls 194. In some cases, the integrated collection bin 190 can be pyramid shaped. The integrated collection bin 190 can be located near the distal end 142 of the handle 130, such that the flared distal end 142 and the sheath guard 122 can be located centrally over the top opening 192. In use, the user can retract the plunger 170 so that the collected swarf enters the integrated collection bin 190 via the top opening 192. The user can then remove the swarf from the integrated collection bin 190. In some cases, the integrated collection bin 190 may be detachable from the handle 130 to allow for easy removal of the collected swarf. In some cases, the integrated collection bin 190 could surround the entire handle 130 so that swarf collection would be covered regardless of the orientation that the device 100 was held in. In other cases, the collection bin 190 could also house one or more magnets to attract the swarf after it is dislodged from the primary magnets 160 in the collection tool 100.

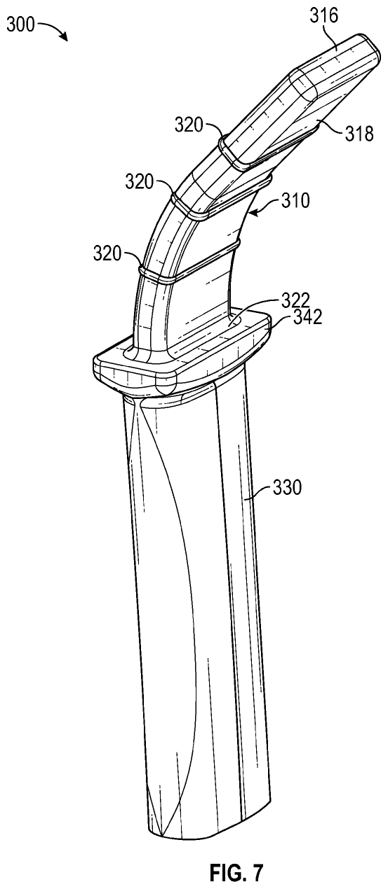

FIG. 7 illustrates a perspective view of an embodiment of a collection tool 300. The collection tool 300 can include some or all of the same components and functionalities as the collection tool 100, as shown and described in relation to at least FIGS. 1A-5B, with the differences noted below. Thus, reference numerals used to designate various features or components of the collection tool 100 are identical to those used for identifying corresponding features of the components of the collection tool 300, except that the numerical identifiers for the collection tool 300 include a “3” instead of a “1”.

The collection tool 300 differs from the collection tool 100 primarily in that the sheath 310 has a natural curved shape instead of a straight shape. Including a curved sheath 310 may provide a benefit when accessing specific curved locations, such as between the body 210 and the base 220 of the sharpener 200, shown in FIG. 3. In some cases, the sheath 310 may be flexible, similar to the sheath 110. In other cases, the sheath 310 may be rigid or semi-rigid. While not shown in FIG. 6, the collection tool 300 can include a magnet holder, one or more magnets, and/or a plunger that are similar or identical to the magnet holder 150, magnets 160, and plunger 170 respectively.

### EXAMPLES

Various example embodiments of the disclosure can be described by the following clauses:

Clause 1. A collection tool for collecting metallic debris, the collection tool comprising: a handle comprising: a handle body having a proximal end and a distal end; and a first channel extending through the handle body between a distal opening at the distal end and a proximal opening at the proximal end; a sheath extending from a distal end of the handle body, the sheath comprising: a sheath body; and a second channel extending through the sheath body between a distal end and a proximal opening at the proximal end, the proximal opening of the second channel aligned with the distal opening of the first channel; and a plunger comprising: a plunger body comprising one or more magnets, the plunger body configured to move the one or more magnets along the first channel and the second channel; and a plunger handle positioned at a proximal end of the plunger body; wherein the plunger handle is configured to move the plunger between a first configuration and a second configuration, wherein the one or more magnets are positioned near the distal end of the second channel in the first configuration and the one or more magnets are positioned within the first channel in the second configuration.

Clause 2. The collection tool of Clause 1, wherein the sheath is formed from an elastomeric material.

Clause 3. The collection tool of Clause 2, wherein the elastomeric material is at least one of silicone, plastic, rubber, elastomer, or Thermoplastic Polyurethane.

Clause 4. The collection tool of any of Clauses 1 to 3, wherein the sheath is configured to elastically deform from a relaxed state when a force is applied to the sheath.

Clause 5. The collection tool of any of Clauses 1 to 4, wherein the collection tool is configured to accumulate metallic debris on an external surface of the sheath body in the first configuration and release the metallic debris from the external surface in the second configuration.

Clause 6. The collection tool of any of Clauses 1 to 5, wherein the sheath further comprises one or more ridges, the one or more ridges formed on an external surface and extending laterally around the sheath.

Clause 7. The collection tool of Clause 6, wherein the one or more ridges are spaced apart along a length of the sheath.

Clause 8. The collection tool of any of Clauses 1 to 7, wherein the sheath further comprises a guard portion near its proximal end, wherein the guard portion abuts the distal end of the handle and prevents the metallic debris from moving past the distal end of the handle.

Clause 9. The collection tool of any of Clauses 1 to 8, wherein the plunger comprises a magnet holder configured to secure the one or more magnets.

Clause 10. The collection tool of Clause 9, wherein the magnet holder comprises one or more magnet compartments configured to house the one or more magnets.

Clause 11. The collection tool of Clause 9 or Clause 10, wherein the one or more magnets are coupled to the magnet holder with an adhesive.

Clause 12. The collection tool of any of Clauses 9 to 11, wherein the one or more magnets are shrink wrapped to the magnet holder.

Clause 13. The collection tool of any of Clauses 9 to 12, wherein the proximal opening is sized to prevent the magnet holder from passing through the proximal opening.

Clause 14. The collection tool of any of Clauses 1 to 13, further comprising a collection bin coupled to the handle, the collection bin configured to collect the metallic debris released from the collection tool.

Clause 15. The collection tool of any of Clauses 1 to 14, further comprising a disposable sheath cover positioned over at least a portion of the sheath body.

Clause 16. The collection tool of any of Clauses 1 to 15, wherein the sheath body is a uniform shape.

Clause 17. The collection tool of Clause 1 or Clauses 5-16, wherein the sheath comprises a rigid material.

Clause 18. The collection tool of Clause 17, wherein the sheath is fixed at a defined curvature.

Clause 19. A method comprising: using the collection tool of any of Clauses 1 to 18; moving the plunger to a first configuration, wherein the one or more magnets are positioned near the distal end of the second channel in the first configuration; collecting metallic debris at the distal end of the sheath; and moving the plunger to a second configuration, wherein the one or more magnets are positioned within the first channel in the second configuration, wherein the metallic debris is released from the sheath when the plunger is moved to the second configuration. 20.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include these features, elements and/or states.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

Additionally, features described in connection with one embodiment can be incorporated into another of the disclosed embodiments, even if not expressly discussed herein, and embodiments having the combination of features still fall within the scope of the disclosure. For example, features described above in connection with one embodiment can be used with a different embodiment described herein and the combination still fall within the scope of the disclosure.

It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added.

Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Reference to any prior art in this description is not, and should not be taken as, an acknowledgement or any form of suggestion that that prior art forms part of the common general knowledge in the field of endeavor in any country in the world.

The invention may also be said broadly to consist in the parts, elements and features referred to or indicated in the description of the application, individually or collectively, in any or all combinations of two or more of said parts, elements or features.

Where, in the foregoing description, reference has been made to integers or components having known equivalents thereof, those integers are herein incorporated as if individually set forth. In addition, where the term “substantially” or any of its variants have been used as a word of approximation adjacent to a numerical value or range, it is intended to provide sufficient flexibility in the adjacent numerical value or range that encompasses standard manufacturing tolerances and/or rounding to the next significant figure, whichever is greater.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. The following lists have example embodiments that are within the scope of this disclosure. The example embodiments that are listed should in no way be interpreted as limiting the scope of the embodiments. Various features of the example embodiments that are listed can be removed, added, or combined to form additional embodiments, which are part of this disclosure:

1. A collection tool for collecting metallic debris, the collection tool comprising:
a handle comprising:
a handle body having a proximal end and a distal end; and
a first channel extending through the handle body between a distal opening at the distal end and a proximal opening at the proximal end;
a sheath extending from the distal end of the handle body, the sheath comprising:
a sheath body; and
a second channel extending through the sheath body between a distal end and a proximal opening at the proximal end, the proximal opening of the second channel aligned with the distal opening of the first channel; and
a plunger comprising:
a plunger body comprising one or more magnets, the plunger body configured to move the one or more magnets along the first channel and the second channel; and
a plunger handle positioned at a proximal end of the plunger body,
wherein the plunger handle is configured to move the plunger between a first configuration and a second configuration, wherein the one or more magnets are positioned near the distal end of the second channel in the first configuration and the one or more magnets are positioned within the first channel in the second configuration.

2. The collection tool of claim 1, wherein the sheath is formed from an elastomeric material.

3. The collection tool of claim 2, wherein the elastomeric material is at least one of silicone, plastic, rubber, elastomer, or Thermoplastic Polyurethane.

4. The collection tool of claim 1, wherein the sheath is configured to elastically deform from a relaxed state when a force is applied to the sheath.

5. The collection tool of claim 1, wherein the collection tool is configured to accumulate metallic debris on an external surface of the sheath body in the first configuration and release the metallic debris from the external surface in the second configuration.

6. The collection tool of claim 1, wherein the sheath further comprises one or more ridges, the one or more ridges formed on an external surface and extending laterally around the sheath.

7. The collection tool of claim 5, wherein the one or more ridges are spaced apart along a length of the sheath.

8. The collection tool of claim 1, wherein the sheath further comprises a guard portion near its proximal end, wherein the guard portion abuts the distal end of the handle body and prevents the metallic debris from moving past the distal end of the handle body.

9. The collection tool of claim 1, wherein the plunger comprises a magnet holder configured to secure the one or more magnets.

10. The collection tool of claim 9, wherein the magnet holder comprises one or more magnet compartments configured to house the one or more magnets.

11. The collection tool of claim 9, wherein the one or more magnets are coupled to the magnet holder with an adhesive.

12. The collection tool of claim 9, wherein the one or more magnets are shrink wrapped to the magnet holder.

13. The collection tool of claim 9, wherein the proximal opening of the first channel is sized to prevent the magnet holder from passing through the proximal opening of the first channel.

14. The collection tool of claim 1, further comprising a collection bin coupled to the handle, the collection bin configured to collect the metallic debris released from the collection tool.

15. The collection tool of claim 1, further comprising a disposable sheath cover positioned over at least a portion of the sheath body.

16. The collection tool of claim 1, wherein the sheath body is a uniform shape.

17. The collection tool of claim 1, wherein the sheath comprises a rigid material.

18. The collection tool of claim 17, wherein the sheath is fixed at a defined curvature.

19. A method comprising:
using the collection tool of claim 1;
moving the plunger to the first configuration;
collecting metallic debris at the distal end of the sheath; and
moving the plunger to the second configuration,
wherein the metallic debris is released from the sheath when the plunger is moved to the second configuration.
